(19) United States
(12) Patent Application Publication
(10) Pub. No.: US 2020/0044215 A1
(43) Pub. Date: Feb. 6, 2020

(54) BASE PLATE STRUCTURE FOR ELECTRICITY STORAGE PACK, AND ELECTRICITY STORAGE PACK

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Hiroshi SHIMIZU, Mie (JP); Hiroki HIRAI, Mie (JP); Tetsuji TANAKA, Mie (JP); Ryouya OKAMOTO, Mie (JP); Hitoshi TAKEDA, Mie (JP); Ken FURUSAWA, Mie (JP); Tomoki IDOTA, Mie (JP); Yuki FUJIMURA, Mie (JP)

(73) Assignees: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(21) Appl. No.: 16/604,052

(22) PCT Filed: Apr. 2, 2018
(86) PCT No.: PCT/JP2018/014074

§ 371 Date: Oct. 9, 2019

(30) Foreign Application Priority Data
Apr. 10, 2017 (JP) 2017-077425

(51) Int. Cl. H01M 2/10; H01M 2/20; H01M 10/0525

(52) U.S. Cl. CPC H01M 2/1077; H01M 2220/20; H01M 10/0525; H01M 2/206

(57) ABSTRACT

Disclosed is a base plate structure for an electricity storage pack including an electricity storage module including a plurality of electricity storage elements, the base plate structure including: a unit base plate that has a shape having a plurality of sides in a plan view, and on which at least one electricity storage module is to be placed; and a wiring member that is to be connected to the electricity storage module. The unit base plate includes: a plurality of unit routing grooves configured to route the wiring member such that a routing direction of the wiring member can be changed; and a unit coupling portion that is formed on each of the sides, and that is configured to couple the unit base plate to another unit base plate.

### TECHNICAL FIELD

The technique disclosed in the present specification relates to a base plate structure for an electricity storage pack, and more particularly relates to the structure of a base plate on which an electricity storage module composed of a plurality of electricity storage elements is mounted.

### BACKGROUND ART

Conventionally, as a base plate structure on which an electricity storage module composed of a plurality of electricity storage elements is mounted, the base structure described in Patent Document 1 is known, for example. Patent Document 1 discloses an electricity storage pack in which an electricity storage module, and protection members (a relay unit, a current detection member, a fuse), a voltage signal line, and an output bus bar of the electricity storage module, are arranged on one base member (base plate). Patent Document 1 discloses a technique for reducing the size of the electricity storage pack by routing the voltage signal line in the space between the electricity storage module and the base member.

### CITATION LIST

### Patent Document

Patent Document 1: JP 2016-119240A

### SUMMARY OF INVENTION

### Technical Problem

However, according to the above-described technique, the number of electricity storage packs disposed on the base plate, the positions of various members, and the like are fixed. Accordingly, the electricity storage pack is used exclusively for the type of a vehicle on which the electricity storage pack is mounted, such as a hybrid vehicle. That is, conventionally, a plate structure needs to be designed for a specific use according to, for example, the type of a vehicle on which it is to be mounted. Therefore, there has been a need for a versatile base plate structure that need not be designed for a specific use according to the vehicle type or the like.

The technique disclosed in the present specification has been completed based on the above-described circumstances, and provides a versatile base plate structure for an electricity storage pack.

### Solution to Problem

A base plate structure for an electricity storage pack that is disclosed in the present specification is a base plate structure for an electricity storage pack including an electricity storage module including a plurality of electricity storage elements, the base plate structure including: a unit base plate that has a shape having a plurality of sides in a plan view, and on which at least one electricity storage module is to be placed; and a wiring member that is to be connected to the electricity storage module, wherein the unit base plate includes: a plurality of unit routing grooves configured to route the wiring member such that a routing direction of the wiring member can be changed; and a unit coupling portion that is formed on each of the sides, and that is configured to couple the unit base plate to another unit base plate.

With this configuration, the unit base plate includes the plurality of unit routing grooves configured to route the wiring member such that the routing direction of the wiring member can be changed, and the unit coupling portion that is formed on each of the sides, and that is configured to couple the unit base plate to another unit base plate. Accordingly, the plurality of unit base plates can be freely coupled via the unit coupling portion. In addition, the wiring member can be freely routed on the plurality of coupled unit base plates using the plurality of unit routing grooves. Accordingly, it is possible to construct a versatile base plate structure for an electricity storage pack that need not be designed for a specific use according to the vehicle type or the like, and is compatible with a plurality of vehicle types or the like.

In the above-described base plate structure for an electricity storage pack, the electricity storage pack may include a plurality of electricity storage modules, and the wiring member may include: an inter-module bus bar configured to connect adjacent electricity storage modules to each other; an output bus bar for extracting electric power from the plurality of electricity storage modules; and a signal line through which a signal relating to a state of the electricity storage modules is to be transmitted.

With this configuration, the inter-module bus bar, the output bus bar, and the signal line serving as the wiring members can be freely routed on the plurality of unit base plates.

In the above-described base plate structure for an electricity storage pack, the plurality of unit routing grooves may be arranged in a grid configuration.

With this configuration, the plurality of unit routing grooves are arranged in a grid configuration, and thus it is possible to easily and suitably form the plurality of unit routing grooves, which are configured to route the wiring member such that the routing direction of the wiring member can be changed.

In the above-described base plate structure for an electricity storage pack, the unit base plate may have a rectangular shape in a plan view.

With this configuration, the shape of the unit base plate is configured to be a rectangular shape in a plan view, and thus the area of the unit base plate can be optimized. That is, ordinarily, the planar shape of the electricity storage module is often configured to be a rectangular shape, and the shape of the unit base plate thus can be matched with the shape of the electricity storage module. Accordingly, it is possible to eliminate wasted space on the unit base plate, thus optimizing the efficiency in area usage of the unit base plate.

In the above-described base plate structure for an electricity storage pack, the unit coupling portion may include a plurality of first coupling portions, and a plurality of second coupling portions that can be coupled to the plurality of first coupling portions, the plurality of first coupling portions may be formed on one of two opposing long sides and one of two opposing short sides, and the plurality of second coupling portions may be formed on the other of the two opposing long sides and the other of the two opposing short sides, the other sides being different from the sides on which the first coupling portions are formed.

With this configuration, when coupling one unit base plate to another unit base plate, it is possible to effectively use each of the sides.

The above-described base plate structure for an electricity storage pack may further include: an auxiliary base plate that has a shape having a plurality of sides in a plan view, that is to be connected to the unit base plate, and on which a protection member of the electricity storage module is to be mounted, wherein the auxiliary base plate may include: a plurality of auxiliary routing grooves configured to route the wiring member such that a routing direction of the wiring member can be changed; and an auxiliary coupling portion that is formed on each of the sides, and that is configured to connect the auxiliary base plate to the unit coupling portion of the unit base plate.

With this configuration, even when the auxiliary base plate on which no electricity storage module is to be mounted is included in the base plate structure, the portions where the auxiliary base plate is coupled to the unit base plate are not fixed on a predetermined side of the unit base plate. Accordingly, it is possible to form a versatile base plate structure for an electricity storage pack.

In the above-described base plate structure for an electricity storage pack, the wiring member may include: an output bus bar for extracting electric power from the plurality of electricity storage modules; and a signal line through which a signal relating to a state of the electricity storage modules is to be transmitted, and the plurality of auxiliary routing grooves may be arranged in a grid configuration.

With this configuration, the output bus bar and the signal line serving as the wiring members can be freely routed on the auxiliary base plate.

In the above-described base plate structure for an electricity storage pack, the unit coupling portion of the unit base plate may include a plurality of first coupling portions, and a plurality of second coupling portions that can be coupled to the plurality of first coupling portions, the auxiliary base plate may have a rectangular shape in a plan view, the auxiliary coupling portion may include a plurality of first auxiliary coupling portions and a plurality of second auxiliary coupling portions, the plurality of first auxiliary coupling portions may be formed on one of two opposing long sides and one of two opposing short sides, and the plurality of second auxiliary coupling portions may be formed on the other of the two opposing long sides and the other of the two opposing short sides, the other sides being different from the sides on which the first auxiliary coupling portions are formed, the first auxiliary coupling portions can be coupled to the second coupling portions of the unit base plate, and the second auxiliary coupling portions can be coupled to the first coupling portions of the unit base plate.

With this configuration, the auxiliary base plate can be easily and freely coupled on any side of the unit base plate. Accordingly, it is possible to further increase the versatility of the base plate structure when the auxiliary base plate is included in the base plate structure.

An electricity storage pack disclosed in the present specification includes: any one of the above-described base plate structures for an electricity storage pack; and the electricity storage module.

With this configuration, it is possible to construct a versatile electricity storage pack including an electricity storage module.

### Advantageous Effects of Invention

According to the present invention, it is possible to construct a versatile base plate structure for an electricity storage pack.

### BRIEF DESCRIPTION OF DRAWINGS

FIG. 1 is a perspective view showing an electricity storage pack according to an embodiment.

FIG. 2 is an exploded perspective view of the electricity storage pack.

FIG. 3 is a perspective view showing an insulating protector.

FIG. 4 is a perspective view showing a base plate structure of the electricity storage pack.

FIG. 5 is a plan view showing the base plate structure of the electricity storage pack.

FIG. 6 is a perspective view showing a unit base plate.

FIG. 7 is a plan view showing the unit base plate.

FIG. 8 is a partial enlarged perspective view of unit base plates, showing unit coupling portions.

FIG. 9 is a partial enlarged plan view of unit base plates, showing unit coupling portions.

FIG. 10 is a partial cross-sectional view taken along the line A-A in FIG. 9.

FIG. 11 is a perspective view showing an auxiliary base plate.

FIG. 12 is a plan view showing the auxiliary base plate.

FIG. 13 is a plan view showing various coupling forms of unit base plates and auxiliary base plates.

### DESCRIPTION OF EMBODIMENTS

### Embodiment

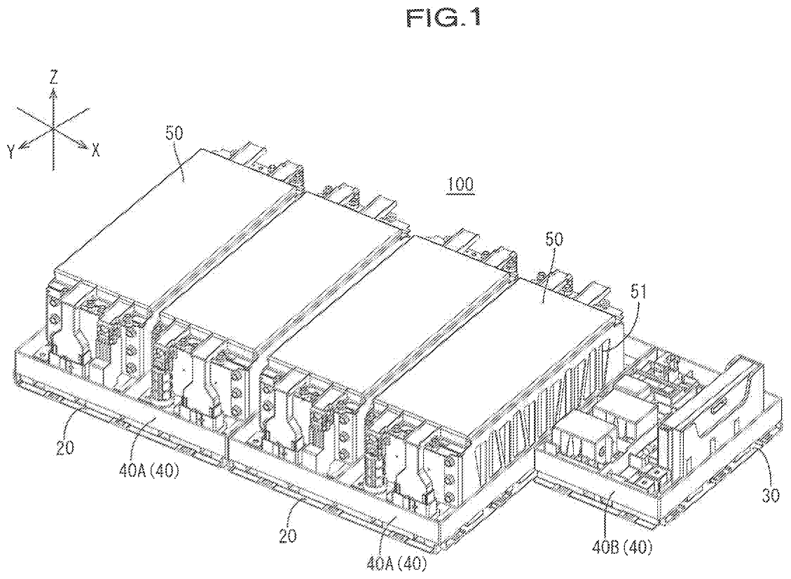

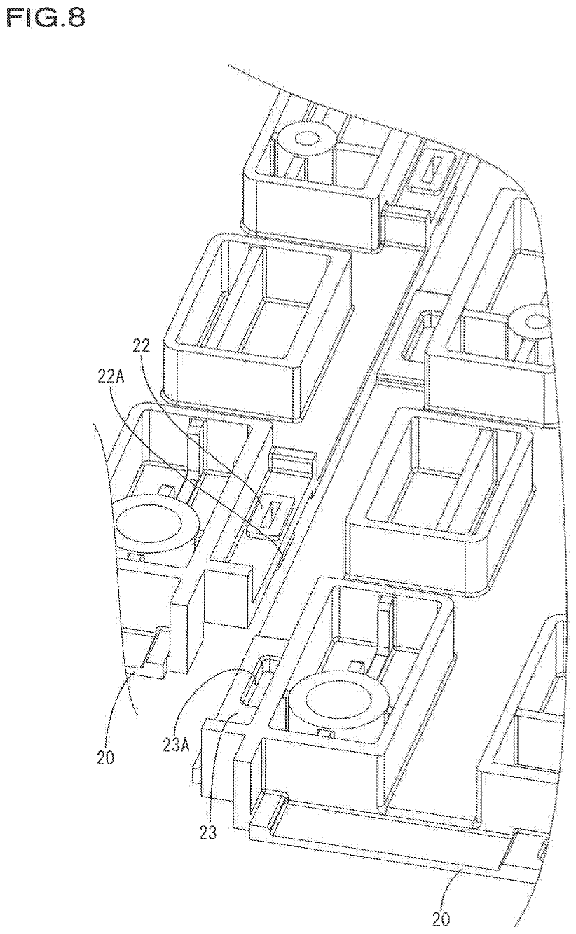

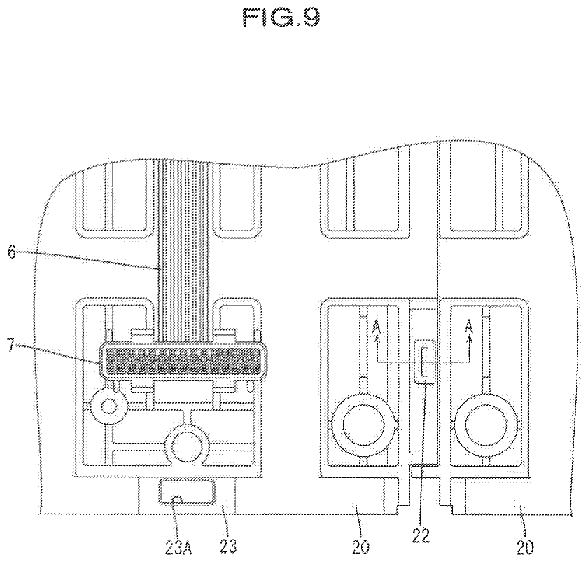

An embodiment of the present invention will be described with reference to FIGS. 1 to 12. An electricity storage pack 100 according to the present embodiment is mounted in a vehicle (not shown) such as an electric vehicle, a hybrid vehicle, and an automobile. Note that the electricity storage pack 100 is not limited to applications in which it is mounted in a vehicle. The following description will be given assuming that the direction indicated by the arrow X in FIG. 1 is the rightward direction, the direction indicated by the arrow Y is the forward direction, and the direction indicated by the arrow Z is the upward direction. Note that the electricity storage pack 100 can be attached in any orientation to a vehicle.

### 1. Configuration of Electricity Storage Pack

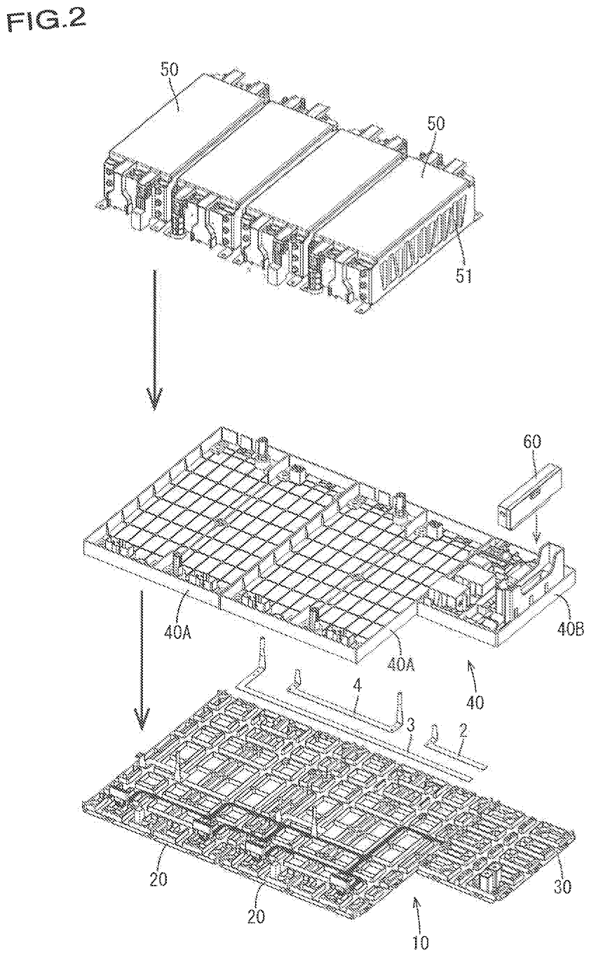

As shown in FIGS. 1 and 2, the electricity storage pack 100 mainly includes a base plate structure 10, an insulating protector 40, and a plurality of (in the present embodiment, four) electricity storage modules 50. Each of the electricity storage modules 50 is composed of a plurality of electricity storage elements 51 that are connected in series. In the present embodiment, each electricity storage element 51 is a lithium ion battery, for example. Note that the electricity storage element 51 is not limited to a lithium ion battery.

The base plate structure 10 mainly includes unit base plates 20 on which the electricity storage modules 50 are mounted, and an auxiliary base plate 30 on which protection members and so forth of the electricity storage modules 50 are mounted. The details of the base plate structure 10 will be described later.

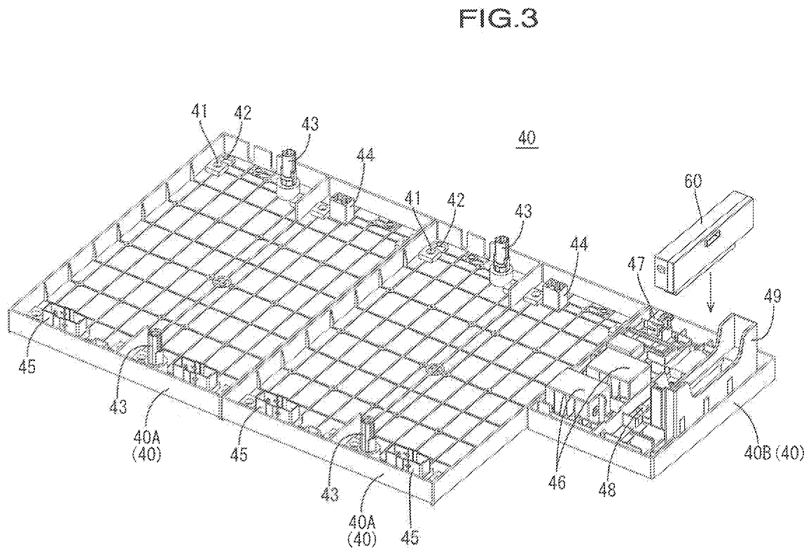

The insulating protector 40 is made of a synthetic resin, for example, and includes two insulating protectors 40A for electricity storage modules, and an insulating protector 40B for protection members and so forth, as shown in FIG. 3. Each insulating protector 40A includes screw holes 41 for fixing the electricity storage modules 50 using bolts or the like, through holes 42 for fixing the insulating protector 40A to the corresponding unit base plate 20, tubular holes 43, prismatic holes 44, and connector holding portions 45. As shown in FIG. 1, two electricity storage modules 50 are placed on each of the insulating protectors 40.

As shown in FIG. 3, relays 46, a current detector 47, a fuse 48 and so forth serving as protection members are attached to the insulating protector 40B for protection members. In addition, a connector socket 49 to which a connector 70 that is to be connected to an ECU or the like is to be connected is attached to the insulating protector 40B.

### 2. Configuration of Base Plate Structure

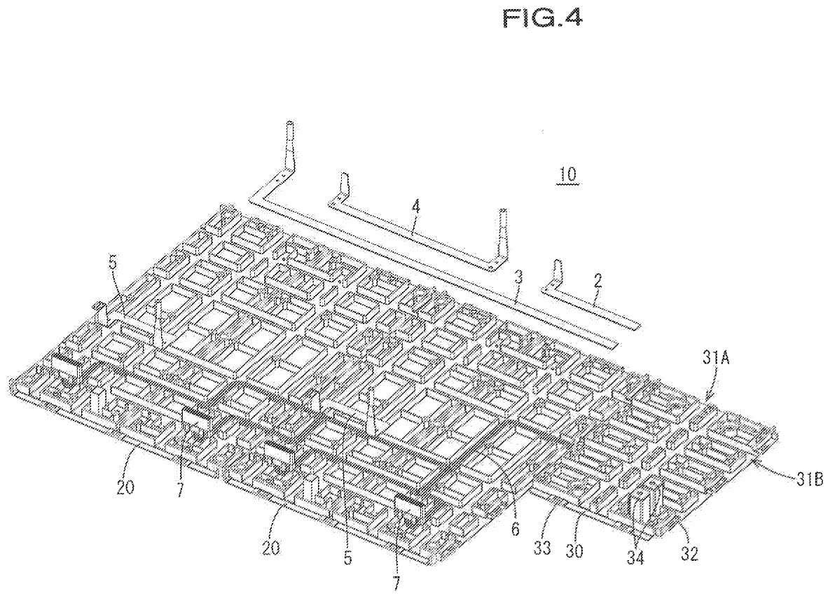

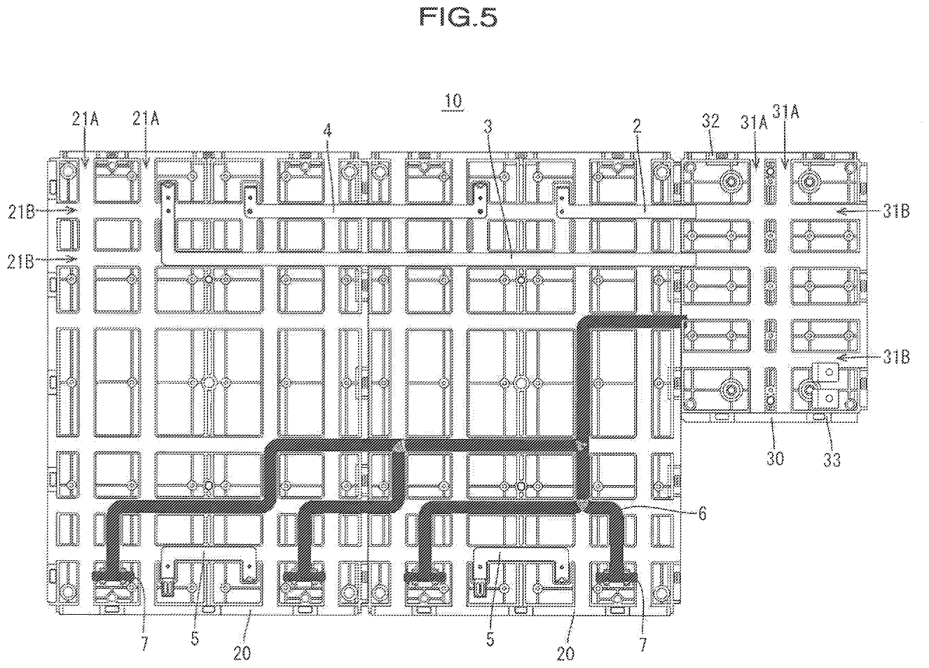

As shown in FIGS. 4 and 5, the base plate structure 10 mainly includes unit base plates 20, wiring members (2, 3, 4, 5, and 6), and an auxiliary base plate 30. Note that, in the present embodiment, the base plate structure 10 includes two unit base plates 20.

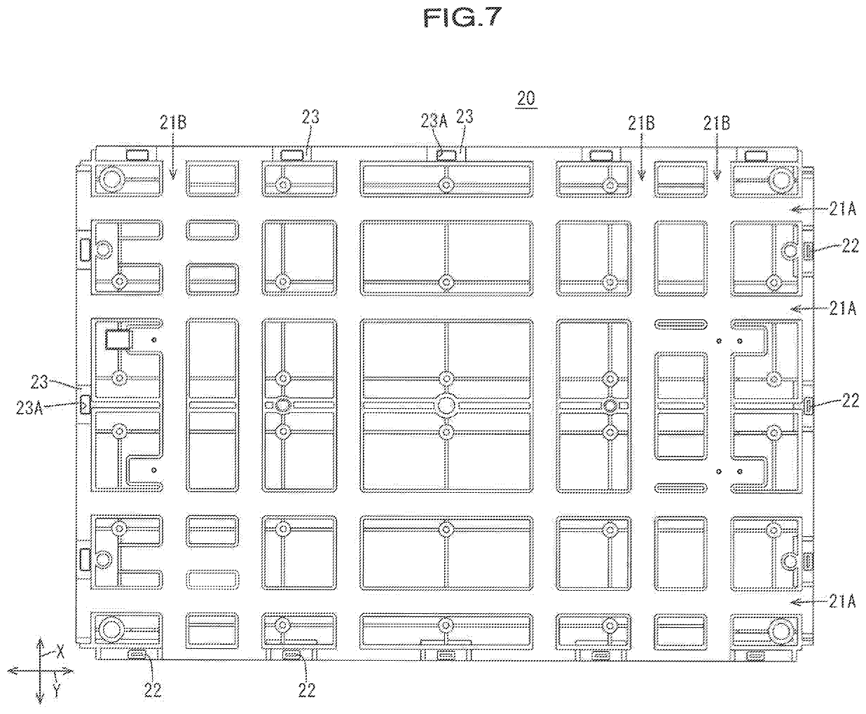

As shown in FIG. 7, each unit base plate 20 has a shape having a plurality of sides (in the present embodiment, a rectangular shape having four sides) in a plan view, and at least one (two in the present embodiment) electricity storage module 50 is placed on the unit base plate 20.

Each unit base plate 20 includes a plurality of unit routing grooves (21A and 21B) configured to route the wiring members (2, 3, 4, 5, and 6) such that their routing directions can be changed, and unit coupling portions (22 and 23) that are formed on the sides.

The unit coupling portions (22 and 23) couple one unit base plate 20 to another unit base plate 20. More specifically, as shown in FIG. 7, the unit coupling portions (22 and 23) include a plurality of first coupling portions 22, and a plurality of second coupling portions 23 that can be coupled to the plurality of first coupling portions 22. The plurality of first coupling portions 22 are formed on one of two opposing long sides and one of two opposing short sides, and the plurality of second coupling portions 23 are formed on the other of the two opposing long sides and the other of the two opposing short sides, the other sides being different from the sides on which the first coupling portions 22 are formed. In other words, the plurality of first coupling portions 22 are formed on one of two opposing long sides, and also formed on one of two opposing short sides. On the other hand, the plurality of second coupling portions 23 are formed on the other of the two opposing long sides, and also formed on the other of the two opposing short sides.

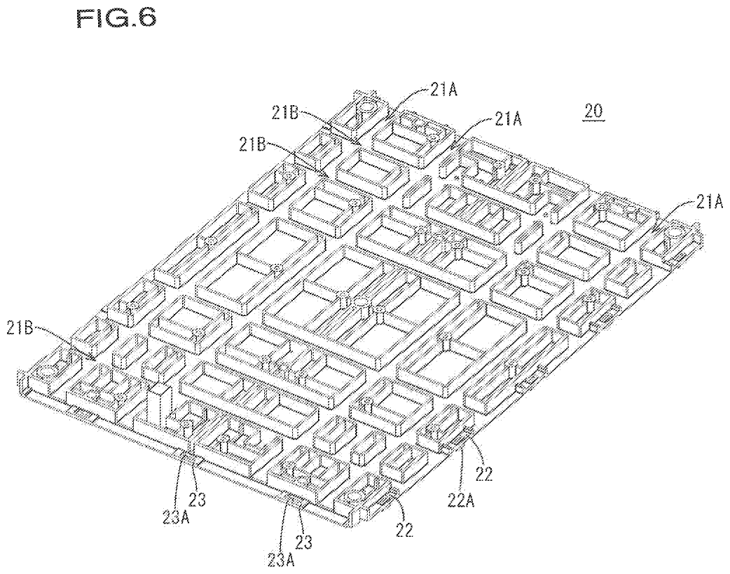

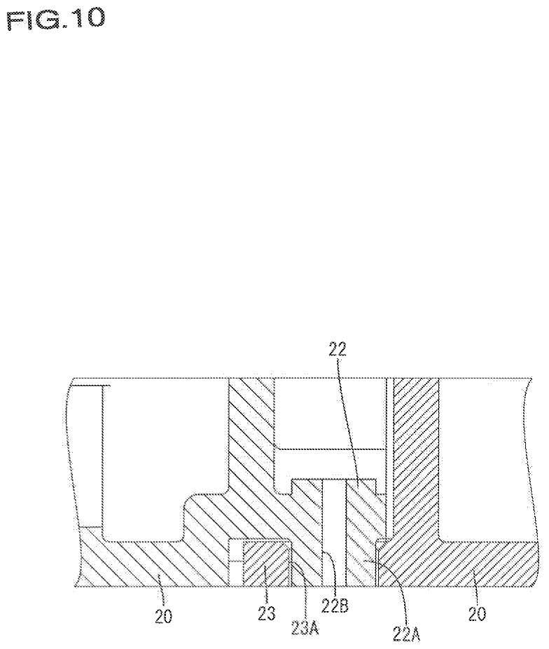

More specifically, as shown in FIGS. 6, 8, 10 and so forth, in the present embodiment, each first coupling portion 22 includes a through hole 22B, and also includes a protrusion 22A that protrudes downward. On the other hand, as shown in FIG. 6, 8, 10 and so forth, each second coupling portion 23 includes a through hole 23A. As shown in FIG. 10, as a result of the protrusion 22A of the first coupling portion 22 being fitted into the through hole 23A of the second coupling portion 23, two adjacent unit base plates 20 are joined.

As shown in FIG. 7, the unit routing grooves (21A and 21B) are arranged in a grid configuration. That is, the unit routing grooves (21A and 21B) are formed by a plurality of longitudinal unit routing grooves 21A extending in the direction indicated by the arrow Y in FIG. 7, and a plurality of transverse unit routing grooves 21B extending in the direction indicated by the arrow X in FIG. 7.

As shown in FIGS. 4 and 5, the wiring members (2, 3, 4, 5, and 6) include inter-module bus bars (4 and 5) that connect adjacent electricity storage modules 50 to each other, output bus bars (2 and 3) for extracting electric power from the plurality of electricity storage modules 50, and a signal line 6 through which a signal relating to a state of the electricity storage modules 50 is to be transmitted. Note that, in the present embodiment, the signal line 6 is a voltage detection line for detecting the voltage of the electricity storage elements 51. One of the output bus bars (2 and 3) is connected to the positive electrode of each electricity storage module 50, and the other is connected to the negative electrode thereof.

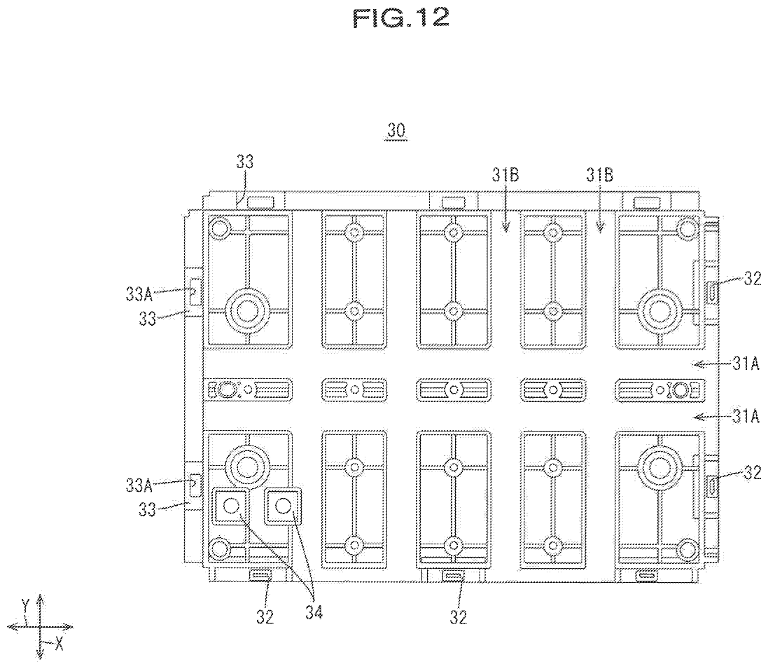

As shown in FIG. 12, the auxiliary base plate 30 has a shape having a plurality of sides (in the present embodiment, a rectangular shape having four sides) in a plan view, and is joined to a unit base plate 20. As described above, the protection members and so forth of the electricity storage modules 50 are mounted on the auxiliary base plate 30. In addition, the auxiliary base plate 30 is provided with electrode terminals 34 for outputting the electric power from the electricity storage modules 50 to the outside.

As in the case of the unit base plates 20, the auxiliary base plate 30 includes a plurality of auxiliary routing grooves (31A and 31B) configured to route the wiring members (2, 3, and 6) such that their routing directions can be changed, and auxiliary coupling portions (32 and 33) that are formed on the sides.

The auxiliary coupling portions (32 and 33) are coupled to the unit coupling portions (22 and 23) of a unit base plate 20 so as to join the auxiliary base plate 30 to the unit base plate 20.

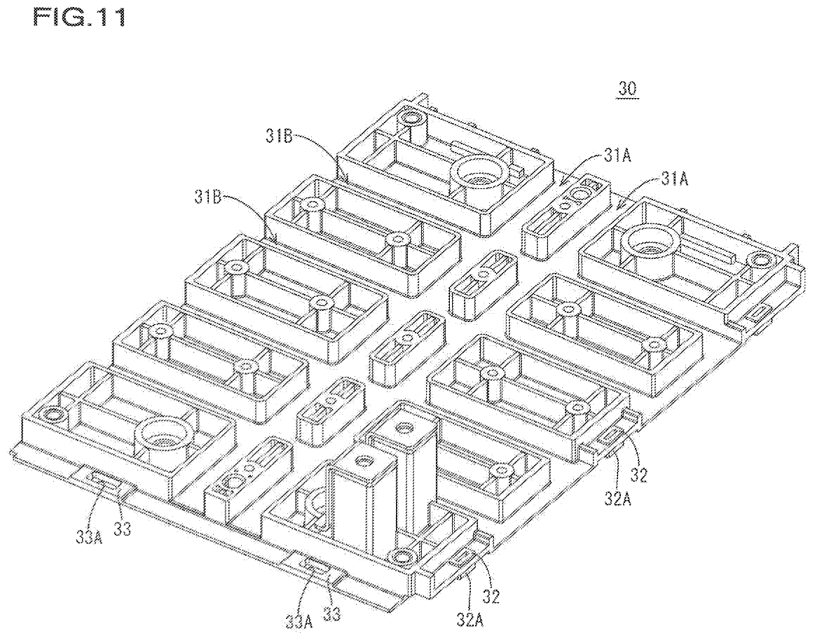

More specifically, as shown in FIGS. 11 and 12, the auxiliary coupling portions (32 and 33) include a plurality of first auxiliary coupling portions 32, and a plurality of second auxiliary coupling portions 33 that can be coupled to the plurality of first auxiliary coupling portions 32. The plurality of first auxiliary coupling portions 32 are formed on one of two opposing long sides and one of two opposing short sides, and the plurality of second auxiliary coupling portions 33 are formed on the other of the two opposing long sides and the other of the two opposing short sides, the other sides being different from the sides on which the first auxiliary coupling portions 32 are formed. In other words, the plurality of first auxiliary coupling portions 32 are formed on one of two opposing long sides, and also formed on one of two opposing short sides. On the other hand, the plurality of second auxiliary coupling portions 33 are formed on the other of the two opposing long sides, and also formed on the other of the two opposing short sides.

Here, the first auxiliary coupling portions 32 have the same configuration as that of the first coupling portions 22 of the unit base plates 20, and the second auxiliary coupling portions 33 have the same configuration as that of the second coupling portions 23 of the unit base plates 20. That is, each first coupling portion 22 has a hollow protrusion 32A that protrudes downward, as shown in FIGS. 11 and 12. On the other hand, each second auxiliary coupling portion 33 has a through hole 33A, as shown in FIGS. 11 and 12. Accordingly, the first auxiliary coupling portions 32 can be coupled to the second coupling portions 23 of each unit base plate 20, and the second auxiliary coupling portions 33 can be coupled to the first coupling portions 22 of the unit base plate. More specifically, in the present embodiment, as shown in FIG. 5, the auxiliary base plate 30 is joined to a unit base plate 20 as a result of the protrusions 22A of the first coupling portions 22 being fitted into the through holes 33A of the second auxiliary coupling portions 33.

As shown in FIGS. 11 and 12, the auxiliary routing grooves (31A and 31B) are arranged in a grid configuration, as in the case of the unit routing grooves (21A and 21B). That is, the auxiliary routing grooves (31A and 31B) are formed by a plurality of longitudinal unit routing grooves 31A extending in the direction indicated by the arrow Y in FIG. 12, and a plurality of transverse unit routing grooves 31B extending in the direction indicated by the arrow X in FIG. 12.

The wiring members (2, 3, and 6) include output bus bars (2 and 3) for extracting electric power from the plurality of electricity storage modules 50, and a signal line (the voltage detection line in the present embodiment) 6 through which a signal relating to a state of the electricity storage modules 50 is to be transmitted. Note that, in FIG. 5 and so forth, the details of the routing of the wiring members (2, 3, and 6) on the auxiliary base plate 30 have been omitted.

### 3. Production Process of Electricity Storage Pack

Next, an example of the production process of the electricity storage pack 100 according to the present embodiment will be described. Note that the production process of the electricity storage pack 100 is not limited to the following description.

As shown in FIGS. 6 and 11, each of the unit base plates 20 and the auxiliary base plate 30 is formed in a predetermined shape using an insulating synthetic resin. Then, two unit base plates 20 are joined to each other, and the auxiliary base plate 30 is joined to the unit base plates 20.

Then, as shown in FIGS. 4 and 5, the output bus bars (2 and 3) are attached to the unit base plates 20 and the auxiliary base plate 30 via the unit routing grooves (21A and 21B) and the auxiliary routing grooves (31A and 31B). In addition, the inter-module bus bars (4 and 5) are attached to the unit base plates 20 via the unit routing grooves (21A and 21B). Furthermore, the voltage detection line 6 is attached to the unit base plates 20 and the auxiliary base plate 30 via the unit routing grooves (21A and 21B) and the auxiliary routing grooves (31A and 31B).

Then, the insulating protectors 40A are attached onto the respective corresponding unit base plates 20, and the insulating protector 40B for protection members on which the protection members are attached is attached onto the auxiliary base plate 30.

Then, the electricity storage modules 50 are attached onto the respective corresponding insulating protectors 40A, and, thus, an electricity storage pack 100 as shown in FIG. 1 is completed.

### 4. Actions and Effects of the Embodiment

In the present embodiment, each unit base plate 20 includes a plurality of unit routing grooves (21A and 21B) configured to route wiring members (2, 3, 4, 5, and 6) such that their routing directions can be changed, and unit coupling portions (22 and 23) that are formed on each side, and that are configured to couple one unit base plate 20 to another unit base plate 20. Accordingly, the plurality of unit base plates 20 can be freely coupled via the unit coupling portions (22 and 23). In addition, the wiring members (2, 3, 4, 5, and 6) can be freely routed on the plurality of coupled unit base plates 20 using the plurality of unit routing grooves (21A and 21B). Accordingly, it is possible to construct a versatile base plate structure 10 for an electricity storage pack that need not be designed for a specific use according to the vehicle type or the like, and is compatible with a plurality of vehicle types or the like.

At this time, the inter-module bus bars (4 and 5), the output bus bars (2 and 3), and the voltage detection line 6 serving as the wiring members can be freely routed on two (a plurality of) unit base plates 20 via the plurality of unit routing grooves (21A and 21B).

In addition, the output bus bars (2 and 3), the inter-module bus bar 4, and the voltage detection line 6 can be routed as members that span adjacent unit base plates 20, or span the unit base plate 20 and the auxiliary base plate 30, after joining the plates. Accordingly, it is possible to omit the process of connecting the plates to each other using connectors, and the process of fastening the plates to each other using bolts, and it is thus possible to reduce the number of processes, and reduce the number of connection components between the plates. Furthermore, the wiring can be performed within the base plates (20, 30), and it is thus possible to reduce the space used for for wiring.

The plurality of unit routing grooves (21A and 21B) are arranged in a grid configuration. Accordingly, the plurality of unit routing grooves configured to route the wiring members such that their routing directions can be changed can be constructed easily and in a configuration that is convenient for routing.

The shape of each unit base plate 20 is configured to be a rectangular shape in a plan view, and thus the area of the unit base plate 20 can be optimized. That is, ordinarily, the planar shape of the electricity storage module 50 is often configured to be a rectangular shape, and the shape of the unit base plate 20 can thus be matched with the shape of the electricity storage module 50. Accordingly, it is possible to eliminate wasted space on the unit base plate 20, thus optimizing the efficiency in area usage of the unit base plate 20.

The plurality of first coupling portions 22 of each unit base plate 20 are formed on one of two opposing long sides and one of two opposing short sides, and the plurality of second coupling portions 23 are formed on the other of the two opposing long sides and the other of the two opposing short sides, the other sides being different from the sides on which the first coupling portions 22 are formed. Accordingly, when coupling one unit base plate 20 to another unit base plate 20, it is possible to couple the other unit base plate 20 to each of the sides of the one unit base plate 20. That is, when coupling one unit base plate to another unit base plate, it is possible to effectively use each of the sides. Accordingly, it is possible to increase the versatility of the base plate structure 10.

The auxiliary base plate 30 on which the protection members of each electricity storage module 50 are to be mounted includes a plurality of auxiliary routing grooves (31A and 31B) configured to route the wiring members such that the routing direction of the wiring members can be changed, and auxiliary coupling portions (32 and 33) that are formed on each of the sides, and that are configured to connect the auxiliary base plate 30 to the unit coupling portions (21 and 22) of each unit base plate 20. Accordingly, even when the auxiliary base plate 30 is included in the base plate structure 10, the portions where the auxiliary base plate 30 is coupled to the unit base plate 20 are not fixed on a predetermined side of the unit base plate 20, and it is thus possible to form a versatile base plate structure for an electricity storage pack.

At this time, the output bus bars (2 and 3) and the voltage detection line 6 serving as the wiring members can be freely routed on the auxiliary base plate 30 via the plurality of auxiliary routing grooves (31A and 31B).

The plurality of first auxiliary coupling portions 32 of the auxiliary base plate 30 are formed on one of two opposing long sides and one of two opposing short sides, and the plurality of second auxiliary coupling portions 33 are formed on the other of the two opposing long sides and the other of the two opposing short sides, the other sides being different from the sides on which the first auxiliary coupling portions 32 are formed. The first auxiliary coupling portions 32 can be coupled to the second coupling portions 23 of the unit base plate 20, and the second auxiliary coupling portions 33 can be coupled to the first coupling portions 22 of the unit base plate 20. With this configuration, the auxiliary base plate 30 can be easily and freely coupled to any side of the unit base plate. Accordingly, it is possible to increase the versatility of the base plate structure 10 when the auxiliary base plate 30 is included in the base plate structure 10.

The electricity storage pack 100 of the present embodiment includes the base plate structure 10 of the present embodiment. Accordingly, it is possible to construct a versatile electricity storage pack 100 that need not be designed for a specific use according to, for example, the type of a vehicle on which it is to be mounted. At this time, it is possible to provide an electricity storage pack 100 according to the vehicle space simply by modifying the wiring.

### Other Embodiments

The present invention is not limited to the embodiment described and illustrated above, and, for example, the following embodiments also fall within the technical scope of the present invention.

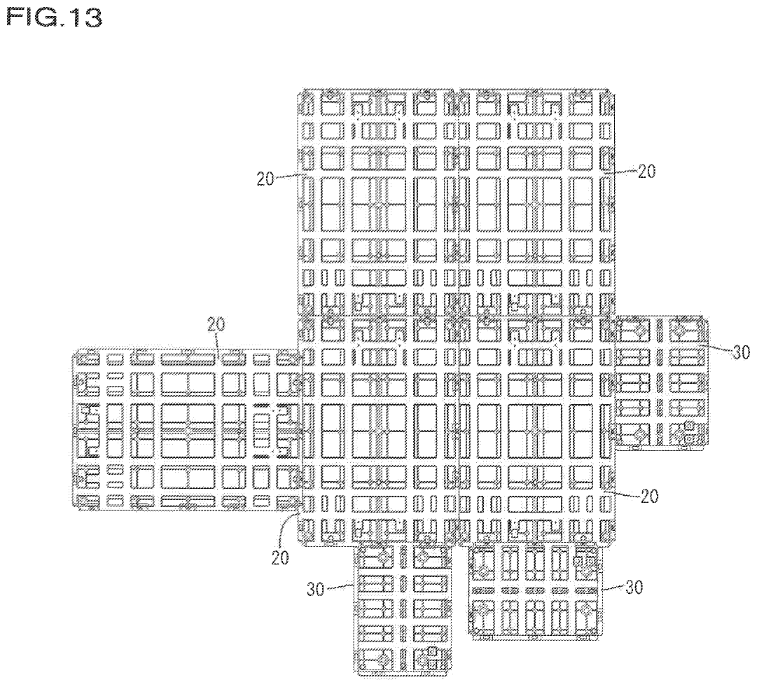

(1) The above-described embodiment shows an example in which, as shown in FIG. 4, the base plate structure 10 is formed by two unit base plates 20 and one auxiliary base plate 30, and each of the plates is coupled on a long side of its rectangular shape; however, the configuration and the coupling form of the plates of the base plate structure 10 are not limited thereto. As shown in FIG. 13, the number of unit base plates 20 is not limited to two, and short sides of two adjacent unit base plates 20 may be coupled to each other. A short side of the auxiliary base plate 30 may be coupled to a short side of a unit base plate 20, or may be coupled to a long side of a unit base plate 20. Furthermore, the number of auxiliary base plates 30 is also not limited to one.

That is, the configuration of the base plate structure 10 can be adapted as necessary according to, for example, the arrangement configuration, the number (capacity), and the like of the electricity storage modules 50 of the electricity storage pack 100 using the configuration of the coupling portions (22 and 23) of the unit base plate 20 and the configuration of the coupling portions (32 and 33) of the auxiliary base plate 30.

(2) Although the above-described embodiment shows the output bus bars (2 and 3), the inter-module bus bars (4 and 5), and the voltage detection line 6 as examples of the wiring members, the wiring members are not limited thereto. For example, a temperature detection line may further be included as a wiring member.

(3) The above-described embodiment shows an example in which the base plate structure 10 includes the auxiliary base plate 30; however, the present invention is not limited thereto, and the auxiliary base plate 30 may be omitted.

(4) Although the above-described embodiment shows an example in which the planar shape of each of the unit base plates 20 and the auxiliary base plate 30 is a rectangular shape, the present invention is not limited thereto. For example, the planar shape of each of the unit base plates 20 and the auxiliary base plate 30 may be a square shape, or may be a hexagonal shape.

(5) The above-described embodiment shows an example in which the plurality of unit routing grooves (21A and 21B) of the unit base plates 20 and the plurality of auxiliary routing grooves (31A and 31B) of the auxiliary base plate 30 have a linear shape, and are arranged in a grid configuration; however, the arrangement configuration of the routing grooves is not limited to a grid configuration. For example, the routing grooves may include a curved portion, or an inclined portion that is inclined at a predetermined angle.

(6) The above-described embodiment shows an example in which the plurality of first coupling portions 22 of the unit base plate 20 are formed on one of two opposing long sides and one of two opposing short sides, and the plurality of second coupling portions 23 are formed on the other of the two opposing long sides and the other of the two opposing short sides, the other sides being different from the sides on which the first coupling portions 22 are formed; however, the configuration in which the coupling portions (22 and 23) are formed is not necessarily limited thereto. For example, the plurality of first coupling portions 22 may be formed on only one of two opposing long sides, and the plurality of second coupling portions 23 may be formed only on the other long side.

Similarly, the above-described embodiment shows an example in which the plurality of first auxiliary coupling portions 32 of the auxiliary base plate 30 are formed on one of two opposing long sides and one of two opposing short sides, and the plurality of second auxiliary coupling portions 33 are formed on the other of the two opposing long sides and the other of the two opposing short sides, the other sides being different from the sides on which the first auxiliary coupling portions 32 are formed; however, the configuration in which the auxiliary coupling portions (32 and 33) are formed is not necessarily limited thereto. For example the plurality of first auxiliary coupling portions 32 may be formed on only one of two opposing long sides, and the plurality of second auxiliary coupling portions 33 may be formed only on the other long side.

### LIST OF REFERENCE NUMERALS

2, 3 Output bus bar (wiring member)
4, 5 Inter-module bus bar (wiring member)
6 Voltage detection line (signal line: wiring member)
10 Base plate structure
20 Unit base plate
21A Longitudinal unit routing groove
21B Transverse unit routing groove
22 First coupling portion
23 Second coupling portion
30 Auxiliary base plate
31A Longitudinal auxiliary routing groove
31B Transverse auxiliary routing groove
32 First auxiliary coupling portion
33 Second auxiliary coupling portion
50 Electricity storage module
100 Electricity storage pack

1. A base plate structure for an electricity storage pack including an electricity storage module including a plurality of electricity storage elements, the base plate structure comprising:
a unit base plate that has a shape having a plurality of sides in a plan view, and is configured to have at least one electricity storage module placed thereon; and
a wiring member configured to be connected to the electricity storage module,
wherein the unit base plate includes:
a plurality of unit routing grooves configured to route the wiring member such that a routing direction of the wiring member can be changed; and
a unit coupling portion formed on at least one of the plurality of sides, and configured to couple the unit base plate to another unit base plate.

2. The base plate structure for an electricity storage pack according to claim 1,
wherein the electricity storage pack includes a plurality of electricity storage modules, and
the wiring member includes:
an inter-module bus bar configured to connect adjacent electricity storage modules to each other;
an output bus bar for extracting electric power from the plurality of electricity storage modules; and
a signal line through which a signal relating to a state of the electricity storage modules is to be transmitted.

3. The base plate structure for an electricity storage pack according to claim 1,
wherein the plurality of unit routing grooves are arranged in a grid configuration.

4. The base plate structure for an electricity storage pack according to claim 1,
wherein the unit base plate has a rectangular shape in a plan view.

5. The base plate structure for an electricity storage pack according to claim 4,
wherein the unit coupling portion includes a plurality of first coupling portions, and a plurality of second coupling portions configured to be coupled to the plurality of first coupling portions,
the plurality of first coupling portions are formed on one of two opposing long sides and one of two opposing short sides, and
the plurality of second coupling portions are formed on the other of the two opposing long sides and the other of the two opposing short sides, the other sides being different from the sides on which the first coupling portions are formed.

6. The base plate structure for an electricity storage pack according to claim 1, further comprising:
an auxiliary base plate that has a shape having a plurality of sides in a plan view, is configured to be connected to the unit base plate, and is configured to have a protection member of the electricity storage module mounted thereon,
wherein the auxiliary base plate includes:
a plurality of auxiliary routing grooves configured to route the wiring member such that a routing direction of the wiring member can be changed; and
an auxiliary coupling portion formed on at least one of the plurality of sides, and configured to connect the auxiliary base plate to the unit coupling portion of the unit base plate.

7. The base plate structure for an electricity storage pack according to claim 6,
wherein the wiring member includes:
an output bus bar for extracting electric power from the plurality of electricity storage modules; and
a signal line through which a signal relating to a state of the electricity storage modules is to be transmitted, and
the plurality of auxiliary routing grooves are arranged in a grid configuration.

8. The base plate structure for an electricity storage pack according to claim 6,
wherein the unit coupling portion of the unit base plate includes a plurality of first coupling portions, and a plurality of second coupling portions configured to be coupled to the plurality of first coupling portions,
the auxiliary base plate has a rectangular shape in a plan view,
the auxiliary coupling portion includes a plurality of first auxiliary coupling portions and a plurality of second auxiliary coupling portions,
the plurality of first auxiliary coupling portions are formed on one of two opposing long sides and one of two opposing short sides, and
the plurality of second auxiliary coupling portions are formed on the other of the two opposing long sides and the other of the two opposing short sides, the other sides being different from the sides on which the first auxiliary coupling portions are formed,
the first auxiliary coupling portions configured to be coupled to the plurality of second coupling portions of the unit base plate, and
the second auxiliary coupling portions configured to be coupled to the plurality of first coupling portions of the unit base plate.

9. An electricity storage pack comprising:
the base plate structure for an electricity storage pack according to claim 1; and
the electricity storage module.
